(19) United States
(12) Patent Application Publication
(10) Pub. No.: US 2013/0117089 A1
(43) Pub. Date: May 9, 2013

(54) SOFTWARE DISTRIBUTION ON MOBILE NETWORKS

(71) Applicants: Alex PACHIKOV, Mountain View, CA (US); Phil Constantinou, San Francisco, CA (US)

(72) Inventors: Alex PACHIKOV, Mountain View, CA (US); Phil Constantinou, San Francisco, CA (US)

(21) Appl. No.: 13/535,807

(22) Filed: Jun. 28, 2012

Related U.S. Application Data
(60) Provisional application No. 61/555,632, filed on Nov. 4, 2011.

(51) Int. Cl. G06Q 30/02

(52) U.S. Cl. 705/14.26

(57) ABSTRACT

Managing software and service provided to a device by a service provider includes performing a pre-qualification check for availability of a premium promotional version of the service for the device, where the pre-qualification check is performed off-line and includes a determination if the device is in a table of devices for which the premium promotional version is available, performing an online qualification check for availability of a premium promotional version of the service for the device in response to passing the pre-qualification check, and offering the premium promotional version of the service in response to passing the qualification check. The pre-qualification check may include determining if there is already a premium account associated with the device and/or determining if there is already a free service account associated with the device.

### RELATED APPLICATIONS

This application claims priority to U.S. Provisional Application No. 61/555,632, filed Nov. 4, 2011, and entitled “METHOD AND PROCESS FOR OPTIMIZING ‘FREEMIUM’ SOFTWARE DISTRIBUTION ON MOBILE NETWORKS”, which is incorporated by reference herein.

### TECHNICAL FIELD

This application is directed to the field of data processing in telecommunications, and more particularly to the field of software and Internet services on mobile networks.

### BACKGROUND OF THE INVENTION

Significant software distribution comes from bundling software with hardware and/or offering the software for download by network operators. With the proliferation of “freemium” (free+premium) mobile cross-platform software and subscription based online services, such as Evernote, mobile software distribution acquires complex characteristics requiring support both at client/device level and at the service/network. Software vendors enter into multiple distribution and co-promotional arrangements with hardware manufacturers and mobile operators. These arrangements may include time limited premium software offers at no charge to customers, in exchange for royalty payments or increased promotional benefits to software vendor, provided by the mobile operator or/and the device manufacturer. The arrangements may also include revenue sharing with mobile operator and/or device manufacturer charges for subsequent upgrades by customers to premium software/service subscriptions. There also may be in-software advertising offered to customers who elect to use free subscriptions, and not upgrade to the premium version.

Qualifying users on mobile networks may be subject to above-mentioned time limited promotions and accordingly obtain premium software/service subscriptions. After the end of promotion, they may continue paying for premium subscriptions or may become free subscribers. This creates challenging tasks of device/user identification and workflow optimization on large-scale mobile networks with many millions of users. Accordingly, it is desirable to design dedicated, efficient and secure mechanism for information flow between bundled and downloaded software, cloud-based service associated with the software, and mobile operator networks where software is deployed, aimed at verifying user roles and enabling freemium software distribution.

### SUMMARY OF THE INVENTION

According to the system described herein, managing software and service provided to a device by a service provider includes performing a pre-qualification check for availability of a premium promotional version of the service for the device, where the pre-qualification check is performed off-line and includes a determination if the device is in a table of devices for which the premium promotional version is available, performing an online qualification check for availability of a premium promotional version of the service for the device in response to passing the pre-qualification check, and offering the premium promotional version of the service in response to passing the qualification check. The pre-qualification check may include determining if there is already a premium account associated with the device and/or determining if there is already a free service account associated with the device. The qualification check may include determining if an identifier of the device indicates that a qualification check was previously performed for the device and/or providing, via the Internet, an identifier from the device to the service provider. The identifier may be encrypted prior to being transmitted from the device to the service provider. A server may compare the encrypted identifier with a database of previously-provided encrypted identifiers. A device being upgraded to the premium promotional version of the software may use the encrypted identifier as a gift code to obtain the premium promotional service. The device may be a cell phone. The table of devices may be provided by a mobile operator. The device may be initially loaded with a software launcher that determines if the device has a correct version of software prior to the pre-qualification check. The software launcher may cause the correct version of the software to be loaded into the device prior to the pre-qualification check.

According further to the system described herein, computer software, provided in a non-transitory computer-readable medium, manages software and service provided to a device by a service provider. The software includes executable code that performs a pre-qualification check for availability of a premium promotional version of the service for the device, where the pre-qualification check is performed off-line and includes a determination if the device is in a table of devices for which the premium promotional version is available, executable code that performs an online qualification check for availability of a premium promotional version of the service for the device in response to passing the pre-qualification check and executable code that offers the premium promotional version of the service in response to passing the qualification check. The pre-qualification check may include determining if there is already a premium account associated with the device and/or determining if there is already a free service account associated with the device. The qualification check may include determining if an identifier of the device indicates that a qualification check was previously performed for the device and/or providing, via the Internet, an identifier from the device to the service provider. The identifier may be encrypted prior to being transmitted from the device to the service provider. A server may compare the encrypted identifier with a database of previously-provided encrypted identifiers. A device being upgraded to the premium promotional version of the software may use the encrypted identifier as a gift code to obtain the premium promotional service. The device may be a cell phone. The table of devices may be provided by a mobile operator. The device may be initially loaded with a software launcher that determines if the device has a correct version of software prior to the pre-qualification check. The software launcher may cause the correct version of the software to be loaded into the device prior to the pre-qualification check.

Software is installed on mobile devices running on mobile operator's network. Devices are connected to a network which gives the devices Internet access. The devices may also be offline at certain times. Additionally, online services associated with the software as a cloud component of the software may be running on Internet servers separately from or within the mobile operator's network. The services may, inter alia, synchronize data from users' mobile devices with network storage and possibly with other user devices that may or may not run on the same network. Additionally, the online services may control user behavior on the network. In order to use mobile software, the user may be required to have an account with the online service and periodically log in to the account. The user may be running a free version of the online service or a premium (paid) version of the service. Furthermore, the user may switch between free and premium service by subscribing to premium features or by canceling premium subscriptions. Additionally, a mobile operator may offer promotional premium subscriptions to users. Such promotional subscriptions may be valid permanently or for a limited time period. At the end of the period, the user may elect to continue paying to keep premium features or may downgrade account to free subscription. Goals of optimizing freemium software distribution may include identification of qualifying users for promotional offers of premium subscriptions, switching customers to subsequent customer-paid subscriptions or converting them to free usage, revenue sharing with partners from customer-paid subscriptions following an initial promotion, and reducing service fraud, i.e. identifying and cutting off unauthorized users and potential violators.

A multi-tier workflow supporting the above-stated goals may include some, but not necessarily all, of the following:
(a) MDUI's—Mobile Device Unique Identifiers—unique codes embedded in each individual mobile device and allowing, beyond identifying the device itself, identification of model and make of the device. Examples of MDUIs are IMEIs, MEIDs, ESNs (on legacy networks) and other identification codes for mobile devices that exist on today's networks or may be introduced in the future. Examples of model/make identifiers are TAC (Type Allocation Code) portion of IMEI and Manufacturer Code portion of MEID.
(b) Software launcher—promotional software distributed pre-loaded on mobile devices by a mobile operator or a device manufacturer that verifies and, in some cases, updates, full software via Internet downloads.
(c) A dedicated landing Web page of the service directing users to mobile marketplace (app store) to download full software for installation.
(d) Installed software, whether downloaded from a marketplace or application store referred by a landing page, or pre-loaded on mobile device at the time user first accesses it, or loaded by user from another source.
(e) A promotional offer of premium service (on behalf of device manufacturer, mobile operator, distributor or other sponsoring entity), one-time or repetitive as defined by distribution arrangements.
(f) A gift coupon system that issues to users electronic coupons/identifiers entitling them to time limited or permanent premium offers.
(g) Subsequent cycle(s) of premium user-paid and/or free unpaid subscriptions.

In an embodiment, the software that is initially installed on a mobile device is a pre-loaded software launcher. Upon opening, the launcher checks if the user has an appropriate version of the software installed on the mobile device. If needed, the launcher directs the user to a dedicated landing Web page, associated with the online service and promotional offering, which offers the appropriate software download from the marketplace/application store. Users may have the software installed previously. However, the software launcher will check the version of software and disallow using an inappropriate version. After the right version of the software has been installed, the launcher is replaced with the software and removed. The user then runs the software, which may require periodic logins into the online service associated with the software. Users not having service accounts are invited to register.

Registered users of the software and associated online service, upon the first login to the service, may undergo a pre-qualification check and a qualification check. Such two-phase verification is designed for the purposes of: (a) optimizing network traffic by maintaining verification parameters locally on the device so the parameters do not need to be transmitted to the mobile operator network from a large number of devices and occupy significant bandwidth; (b) boosting system performance due to (a) and to instant rejection of a portion of non-qualified users who do not need to go through the network portion of promotional offer; and (c) preventing fraud of the promotional offer by scaling down network data exchange where data interception and modification by potential violators may occur.

At the pre-qualification check, the system verifies locally, on the mobile device, the following:
(i) Whether the user has already enrolled into a promotional premium offer. If so, the user is marked as non-qualifying (nothing left to do with respect to available promotional offer) and the pre-qualification check terminates without further action. A negative answer leads to the next check.
(ii) Whether the user has a free service account. With a negative answer, the user is marked as non-qualifying (already obtained premium service from another sources not related to the promotional offer, possibly directly from the software/service vendor) and the pre-qualification check terminates without further action. Otherwise, the next check is performed.
(iii) Whether a promotional premium offer sponsored by a mobile operator or other entity is available for the user's specific combination of mobile operator and model/make of device (e.g., specific cell phone and carrier). A negative answer completes the pre-qualification check without further action (nothing to offer) and the user is marked as non-qualifying. In the case of a positive answer, the user is marked as pre-qualifying and the pre-qualification check is completed. The qualification check follows.

In an embodiment, data about all combinations of mobile operators and device models in which a promotion is currently available is downloaded and stored on the device with the appropriate version of software. The third verification step (iii, above) may then be performed locally. In another embodiment, only information about the availability of promotional offers for different mobile operators is stored with the downloaded software, while more frequently changing data about device models for each mobile operator where promotions are available is stored with an online service. In such a case, the third verification step (iii, above) of the pre-qualification may only check the mobile operator portion and a check of device specific availability of a promotional offer is moved to the qualification check (discussed in more detail below).

Noted that, since the pre-qualification check is performed locally on mobile devices, the pre-qualification check is relatively resistive to abuse. Of course, there is always a possibility that a harmful code with access to software and service specific data or an infected version of software has been installed on the mobile device.

At the qualification check, pre-qualifying the user devices are logged in to an online service and are further examined. The system starts by verifying if the local flag indicating whether the validity of device MDUI has already been verified previously is on. If the answer is yes, it likely indicates an attempt of breaching the system because MDUI validity is verified only once and the result is recorded on the device. The attempted breach causes the system to display a warning on the user device and mark the device as non-qualifying. If device MDUI has not been previously verified, an encrypted version of the MDUI is sent to the online service. The online service decrypts the MDUI and then determines if the MDUI is in a list of MDUIs previously recorded for users joining a promotional premium offer. If the MDUI is not on the list, the MDUI is added to the list. Note of successful verification of MDUI validity is recorded locally on the device and the mobile device user is marked as qualifying irrespective of whether the MDUI was just added or was already on the list.

Note that it is useful for a decrypted MDUI to be already present on the server-side list even though the local MDUI validity verification flag was set the first time MDUI was added to the list. This protects against the possibility of the user reinstalling software following a complete uninstallation or even reversion of the system to factory defaults (reformat device) after the first verification has been made. Accordingly, transmitting the (encrypted) MDUI to the server on each qualification check is useful to restore a promotional premium offer for any users who have lost the promotional premium offer for various reasons.

Note also that, while a potential violator may intercept an encrypted MDUI being transmitted to the online service, the encrypted MDUI may not be used by a non-qualifying user to improperly enroll in a promotional premium offer. Software installed on the mobile device of the user accesses the MDUI of the device, which is different (for a violator) from the MDUI encrypted with the intercepted data. In order to fake the MDUI, a valid MDUI has to be decrypted from the intercepted data, which is difficult with reliable encryption.

Previous software installation and verification checks identify users qualified for receiving promotional premium offer of online service on their mobile devices. Upon successful completion of the pre-qualification and qualification checks, a message is displayed on the mobile device of the user offering the premium service. If the user accepts, the system upgrades user service account to premium and records account status locally on the mobile device for subsequent pre-qualification checks. In an embodiment, the system may use the encrypted MDUI as a gift code to upgrade the user account to premium status. The system records the code in the gift code database for additional verifications and for easy identification of the user device at the time of expiration of the promotional premium offer. In the event that the user does not accept the premium offer, a local flag that is set to indicate rejection of the offer and the corresponding rejection date are recorded locally on the mobile device. In such a case the user continues using a free version of the software and service without premium features. In an embodiment, the system periodically reminds such users about the availability of the premium version and invites the users to upgrade.

### BRIEF DESCRIPTION OF THE DRAWINGS

Embodiments of the system described herein will now be explained in more detail in accordance with the figures of the drawings, which are briefly explained as follows.

FIG. 1 is a schematic illustration showing goals of a system designed for optimizing software distribution on networks controlled by mobile operators according to an embodiment of the system described herein.

FIG. 2 is a flow diagram showing installing software according to an embodiment of the system described herein.

FIG. 3 is a flow diagram showing running software and determining if a user is entitled to an upgrade according to an embodiment of the system described herein.

FIG. 4 is a flow diagram showing upgrading a user according to an embodiment of the system described herein.

FIG. 5 is a schematic illustration showing organization of mobile operator and device information for handling promotional premium offers according to an embodiment of the system described herein.

FIG. 6 is a flow diagram showing a pre-qualification check performed locally on mobile devices according to an embodiment of the system described herein.

FIG. 7 is a flow diagram showing a qualification check performed by interaction of an online service with mobile devices running on mobile operator's network according to an embodiment of the system described herein.

FIGS. 8A-8D are schematic illustrations showing various user interface components and messages corresponding to several embodiments of the system described herein.

### DETAILED DESCRIPTION OF VARIOUS EMBODIMENTS

The system described herein provides optimization of mobile software and service distribution on wireless wide area networks run by mobile operators. Modern software applications such as, for example, Evernote or Dropbox, in addition to running on a variety of mobile platforms, such as iOS, Android and Windows Phone, may have a “cloud component”, thus combining features of traditional software with features of an online service associated with the software. The service may have features directly tied to software, such as data synchronization or Web clipping, as well as features related to Web presence of the online service. Examples include downloads of software versions for new platforms, Web-based account management, Web publishing and sharing of content created by software, etc. Internet access available to users via mobile networks is utilized for accessing online service both from the software and by visiting Web pages of the service.

According to a so-called “freemium” business model for distribution and usage, software and associated service are available in both free and premium (paid) versions. In some cases, premium versions are subscription based, with subscription periods of one month, one quarter, and one year.

Price discounts may be offered for longer subscription periods. Premium versions may package additional set of software and service features, such as higher network storage and upload quotas, enhanced security, advanced viewing, editing, and data manipulation features, priority access to advanced features available in both free and premium versions, etc. In some cases, users may switch between free and premium versions in any order according to paid subscription periods.

Premium offers of popular software/service products may be attractive to mobile operators. By sponsoring (subsidizing) time-limited premium subscriptions on the mobile networks that are offered to customers at no charge, operators create incentives for the customer base of the operators. While operators may have to pay royalties for such offers to software publishers, the operators may receive price discounts because of high distribution volumes. Additionally, operators may gain new customers from the software publisher's user base and receive revenue share from subsequent, non-subsidized premium subscriptions by customers who decided to keep premium features of the software/service beyond the promotional period. This is beneficial to both mobile operators and software publishers and supports the growth of freemium distribution on mobile networks.

However, the environment for deploying promotional premium offers of software and service on mobile networks is complicated and challenging. For technical, usability and other reasons, a promotional offer may be available only on a portion of models of mobile devices running on a particular network. New device models are added to the network at different times and on tight schedules. Pre-loading and upgrading software on the new devices may be difficult. In addition, users may already have the software running on their other devices and some of the users may even have premium versions of software or premium subscriptions to the service. There also exist risks of fraud and unauthorized access to the promotional offer by non-qualifying users.

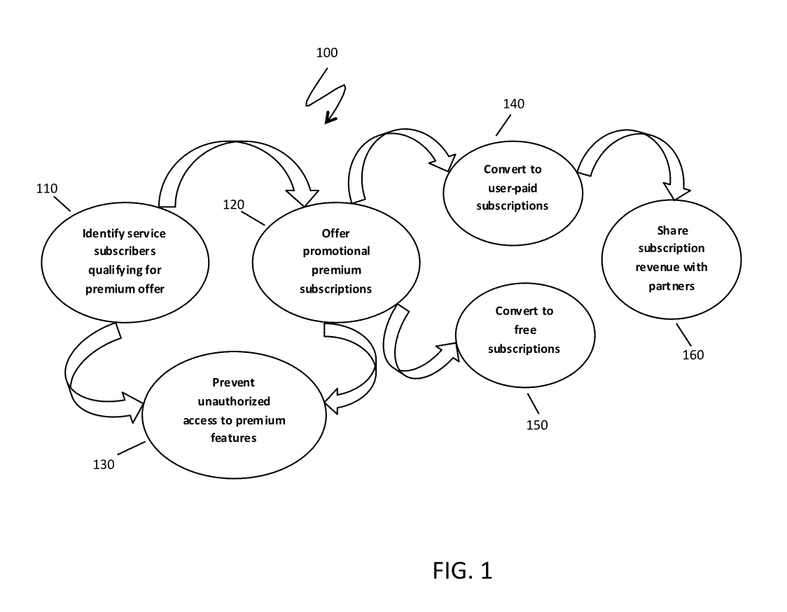

FIG.1 is a schematic illustration of goals of a freemium software distribution model on mobile operator's network. A goal 110 includes identifying, among all users of a network of a mobile operator, service subscribers who qualify for the promotional premium offered by the operator. Qualified users may include users who already have a service account and are running mobile software as well as users who only have either a pre-loaded software launcher on their mobile device or a pre-loaded full version of the software but do not yet possess a service account. The goal 110 is connected to a goal 120 that includes offering a promotional premium subscription service to the qualifying users. The goals 110, 120 are also connected to a goal 130 that requires preventing unauthorized access to premium features by potential violators who may try to fake subscriber identity or otherwise obtain premium subscription, as explained in more detail elsewhere herein.

After expiration of the promotional premium subscription, it is desirable to convert users to paid subscriptions, as illustrated by a goal 140 that is connected to the goal 120. In addition, it is possible that a user converts a promotional premium subscription to the free version, as illustrated by a goal 150 coupled to the goal 120. In the event of converting a user to paid subscription illustrated by the goal 140, in some embodiments, a software publisher identifies such users, calculates revenue from the user-paid subscriptions thereof, and shares the revenue with partners such as mobile operators, device manufacturers, distributors, resellers, etc., as illustrated by a goal 160 connected to the goal 140.

In one embodiment, a mobile operator promotes a premium offer by pre-loading a special monitoring software application, called a software launcher, on mobile devices that are running on the network of the mobile operator and are capable of participation in the promotional premium offer. The software launcher ensures installation of the right version of software on the user's mobile device. The software launcher checks for the presence of software. If software is present, the software launcher checks the version of software, directing the user to landing page of service if the software is absent or the version is wrong. The software launcher and/or the landing page may offer the user a download link; the actual download may be from a marketplace or an application store where the software published keeps the software. Subsequently, the user works with installed software, logs in to a corresponding service and interacts with the service to receive a promotional premium offer if the user is entitled to receive the offer and is interested.

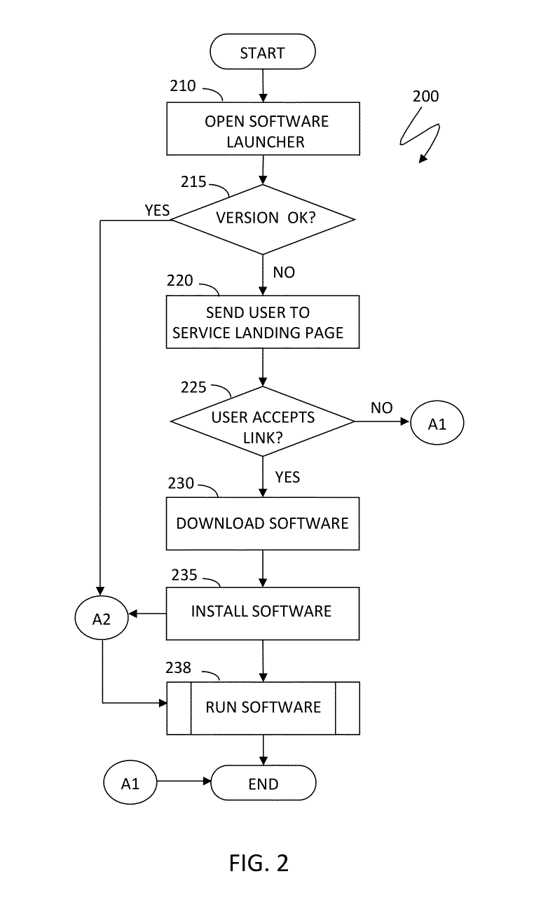

FIG. 2 is a flow diagram 200 showing operation of the software launcher according to an embodiment of the system described herein. As discussed elsewhere herein, a mobile operator may pre-load the user's mobile device with the software launcher. Processing begins at a step 210 where the user opens the software launcher on the user's mobile device. Following the step 210 is a test step 215 where the software launcher determines whether the appropriate version of software is installed on the user's mobile device. If not, then either no software is installed on the mobile device or a wrong version (old version) is installed. In either case, processing proceeds to a step 220 where the user is directed to a Web based landing page of an online service associated with the software. In an embodiment herein, the landing page includes a software download link. An example of such an online service includes services provided by Evernote Corporation (www.evernote.com).

After the step 220, processing proceeds to a test step 225 where it is determined whether the user accepts the software download link (i.e., agrees to download the software). If not, then processing ends, leaving user without functioning software, since the user is not interested in downloading the correct version of software at that time. Otherwise, processing proceeds to a step 230 where the user downloads software from the download location using the download link. Following the step 230, processing proceeds to a step 235 where the user installs the software. Following the step 235, processing proceeds to a step 238 where the user opens and runs the software. Note that the step 238 is also reached from the step 215 if the user already has the correct version of the software. Processing at the step 238 is described in more detail elsewhere herein. Following the step 238, processing is complete.

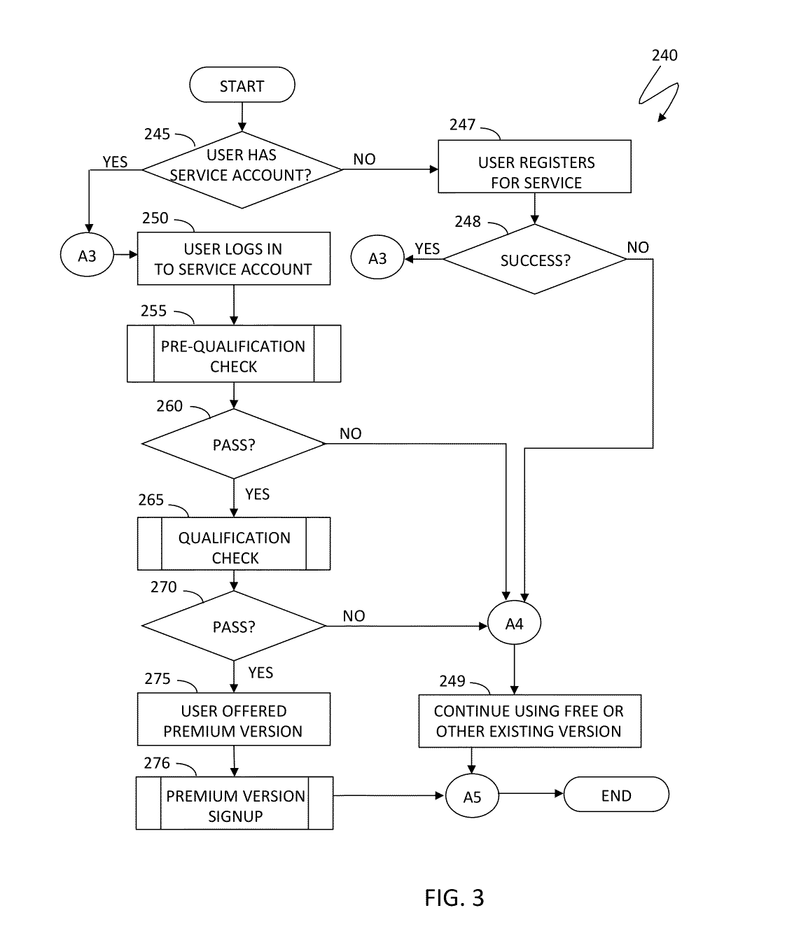

Referring to FIG. 3, a flow diagram 240 illustrates steps performed in connection with the user running the software. Processing for the flow diagram 240 begins at a test step 245 where it is determined whether the user has a service account. If so, processing proceeds to a step 250 where the user logs in to the service account. Otherwise, control transfers to a step 247 where the user is registered for the service. In an embodiment herein, the user may register for the service at the step 247 by providing information such as name, email address, etc. After the step 247, processing proceeds to a test step 248 where it is determined whether the registration was successful. Registration may fail for one of any number of reasons. If registration is not successful, then processing proceeds to a step 249 where the user continues to use the free version of the software or another existing version of the software, if any, without getting access to the promotional premium offer. Following the step 249, processing is complete. In other embodiments, the step 249 is not performed and the system exists leaving user without any functioning software because the user cannot use the software without signing up to the service.

If it is determined at the test step 248 that registration is successful, then processing proceeds to the step 250, discussed above, where the user logs in to the service. Following the step 250, processing proceeds to a step 255 where pre-qualification processing is performed. As explained elsewhere herein, processing for pre-qualification to receive a premium offer may be performed locally, on the user's device, without transferring any data to the service. This decreases occupied bandwidth, speeds up decision-making, and prevents malicious users from improperly accessing user data. Pre-qualification processing at the step 255 is explained in more detail elsewhere herein. Note that that the ability of the system to make a local, pre-qualification check at the step 255 on the device depends upon storing certain information about the availability of promotional premium offers by mobile operator on the device.

Following the step 255, processing proceeds to a test step 260 where it is determined whether the user passes the pre-qualification check at the step 255, discussed above. If not, then processing proceeds to the step 249, discussed above, where the user continues running a free version of the software and service (or a previously obtained through other venues premium version of the software and service) without joining the premium features offered by the mobile operator as a promotion. Following the step 249, processing is complete. If it is determined at the test step 260 that the user has passed the pre-qualification check, then processing proceeds to a step 265 where qualification check processing is performed. As discussed elsewhere herein, qualification check processing includes software and service interaction and Internet data transmission between the software on the mobile device and the service back-end. The processing provided at the step 265 is discussed in more detail elsewhere herein.

After the step 265, processing proceeds to a test step 270 where is determined whether the user qualifies for a premium offer. If not, then processing proceeds to the step 249, discussed above, where the user continues to use the free or other installed version of the software and service. If it is determined at the test step 270 that the user qualifies for a premium offer, processing proceeds to a step 275 where the user is offered a premium version of the software. Following the step 275 is a step 276 where the system handles user input in connection with the offer of the premium version of the software. Processing performed at the step 276 is described in more detail elsewhere herein. Following the step 276, processing is complete.

Note that, for some embodiments, the user may be required to periodically log in to an online service in order to run the software persistently. For other embodiments, the software may be run without necessarily logging in to any online service either periodically or at all. The flow diagram 240 illustrates an embodiment where the user logs in to an online service periodically.

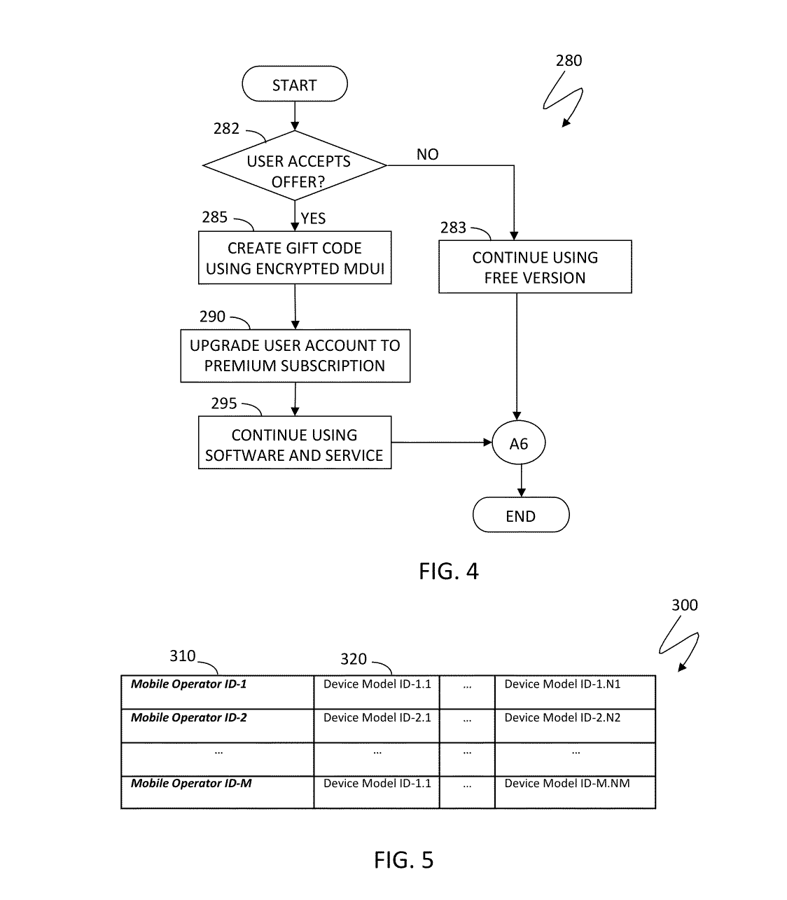

FIG. 4 is a flow diagram 280 that illustrates in detail processing performed at the step 276, discussed above, where the system handles user input in connection with the offer of the premium version of the software. Processing begins at a test step 282 where it is determined whether the user accepts the premium offer. If not, then processing proceeds to a step 283 where the user continues to use the free version of the software and service. Following the step 283, processing is complete.

If the user accepts the offer at the step 282, processing proceeds to a step 285, where a gift code is created using the encrypted MDUI of user's mobile device (discussed elsewhere herein). In the embodiment illustrated by the flow diagram 280, users are upgraded to a premium accounts via a gift code system where gift codes serve as temporary certificates and are stored with the service. The service automatically scans the gift codes and has information about the expiration term of the codes.

As explained elsewhere herein, upgrading user accounts to premium status via encrypted MDUIs is beneficial for the system and users, since it inhibits unauthorized access to premium subscriptions and allows quick identification and additional monitoring of users during the term of the premium subscription, including expiration thereof After the step 285, processing proceeds to a step 290 where the user account is upgraded to a premium subscription. After the step 290, processing proceeds to a step 295 where the user uses the software and service with additional features and benefits of the premium subscription. Following the step 295, processing is complete.

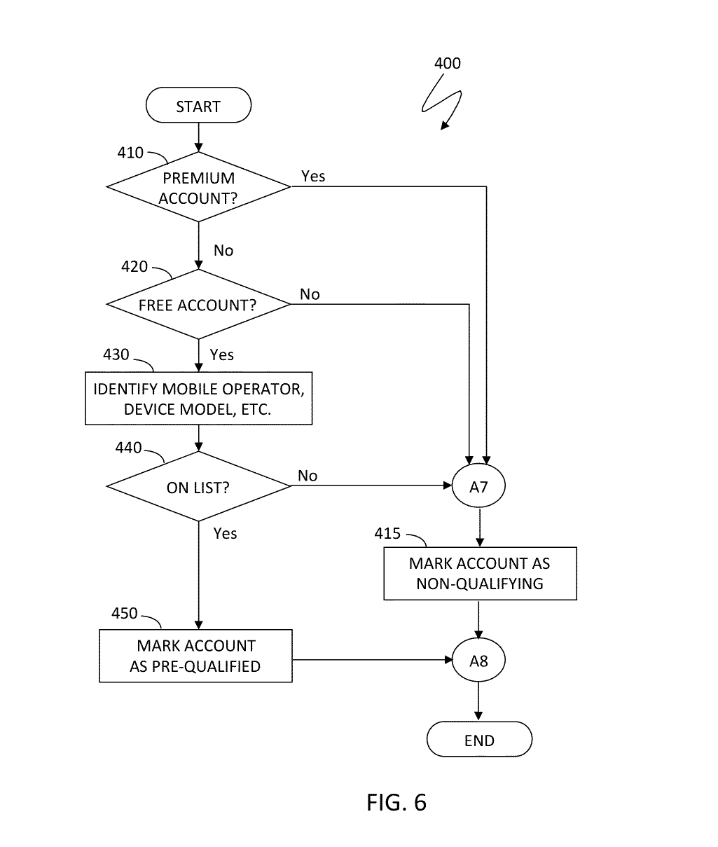

FIG. 5 is a schematic illustration showing a master list 300 that may be stored on a user's device listing mobile operators, devices, and promotional premium offers. The master list 300 may be used in connection with pre-qualification checking and may be provided by the software and service publisher and stored with downloadable and/or bundled software that is provided with every promotional premium offer made by each mobile operator to its customers on some or all of the mobile devices running on a network. The list may be periodically updated synchronously with updating the software and/or service versions. The master list 300 includes entries 310 of network IDs of all mobile operators offering promotional premium subscriptions. The network IDs may be encoded in MDUIs of mobile devices running on an operator's network. Accordingly, each of the entries 310 of the master list 300 may contains a sub-list of ID's 320 of specific mobile devices participating in the promotional premium offer on the corresponding mobile operator network corresponding to one of the entries 310. The device IDs may also be presented in a format in which the IDs are included in MDUIs of the mobile devices. In another embodiment, the master list includes only mobile operator IDs 310, while mobile device info is deployed separately on mobile operator's network and is not downloaded with the software.

Note that the master list 300 facilitates the pre-qualification check being performed faster and more securely. However, each addition of a promotional premium offer for a new model of mobile device on mobile operator's network may require an update to master list 300 and thus obsoletes such lists on previously deployed models of mobile devices. Eventually, this may call for full software upgrade on all devices running on mobile operator's network to consolidate master lists to the latest status of deployment of the promotional premium offer. At the same time, since every unit of a particular new model of a mobile device which participates in the promotion has its own model information pre-loaded on the device with its first customer shipment, consolidation of master list may be a desirable but not strictly mandatory activity. Generally, the more predictable a deployment landscape is, the more information that can be stored on mobile devices with the downloadable software.

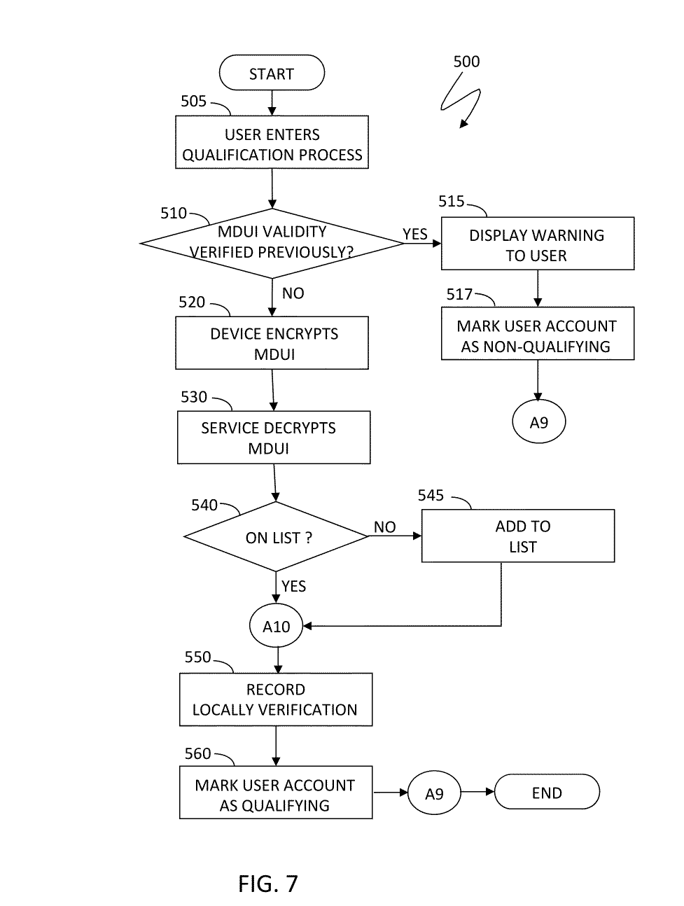

FIG. 6 is a flow diagram 400 showing in more detail processing performed at the step 255, discussed above, where a pre-qualification using the master list 300 of promotional premium offers is performed. As discussed elsewhere herein, pre-qualification checking may be performed using information provided with the device without accessing any service or otherwise contacting another entity online (i.e., via the Internet). Accordingly, the pre-qualification check may be entirely offline without accessing any other entities either through the Internet or otherwise.

Processing begins at a test step 410 where it is determined whether a user already has a promotional premium subscription. If so, then control transfers from the step 410 to a step 415 where the user account is marked as non-qualifying. In an embodiment herein, promotional premium subscriptions are not available to users that already have a premium account. Following the step 415, processing is complete.

If it is determined at the test step 410 that the user does not already have a premium subscription, then control transfers from the step 410 to a test step 420 where it is determined whether the user has a free service account. In an embodiment herein, only users with a free service account may qualify for a promotional premium offer. If it is determined at the test step 420 that the user does not have a free service account, then control transfers to the step 415, described above, where the user account is marked as non-qualifying. This may occur if the user has already signed up for a premium service account independently from the offering, i.e. obtained premium account directly from a software publisher or a distributor which is not a mobile operator. Following the step 415, processing is complete.

Otherwise, if it is determined at the test step 420 that the user does have a free service account, then control transfers to a step 430 where the system uses the device MDUI to extract a mobile operator ID and, in some embodiments, also extract a mobile device model ID. After the step 430, processing proceeds to a test step 440 where information extracted at the step 430 is compared against the master list 300 indicating the availability of promotional premium offers. At the step 440, it is determined whether the user's mobile operator and/or the user's specific mobile device are on the master list 300. If not, then processing proceeds to the step 415, discussed above, where the user account is marked as non-qualifying. Following the step 415, processing is complete. Otherwise, if it is determined at the step 440 that the user's mobile operator and/or the user's specific mobile device are on the master list 300, the pre-qualification check is deemed successfully completed and processing proceeds to a step 450 where the user account is marked as pre-qualifying. Following the step 450, processing is complete.

Pre-qualification checking significantly decreases network load during deployment of promotional premium offers by mobile operators. All users who have previously received premium subscription or have already subscribed to currently active premium offers are marked as non-qualifying without accessing the service over the network. Similarly, users whose mobile operator or combination of mobile operator and device model are not entitled for a promotional premium offer are similarly marked as non-qualifying without accessing the service over the network. Note that a mobile operator or a combination of mobile operator and device model may not be entitled for a promotional premium offer for a variety of reasons. For example, the promotional offer may be terminated for technical or business reasons, a particular device may already be pre-loaded with the software launcher or software but the networking part of the promotional offer may be delayed, etc.

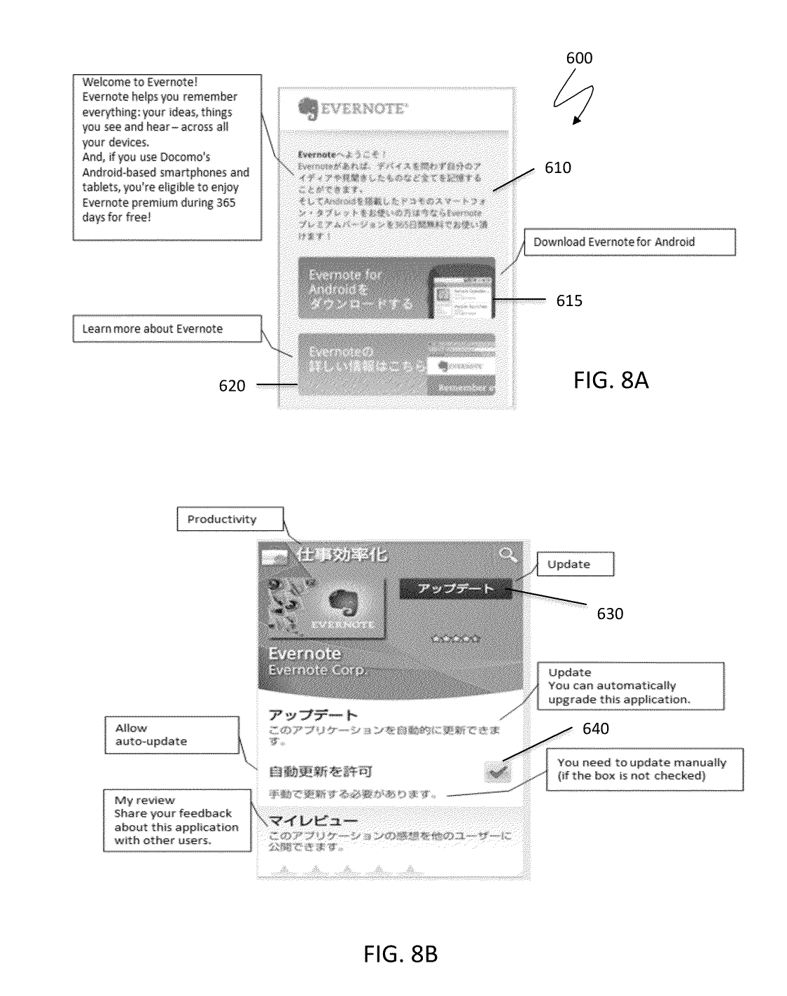

FIG. 7 is a flow diagram 500 illustrating processing performed in connection with a user qualification check. The qualification check may be performed for users/mobile devices that have successfully passed the pre-qualification check, described elsewhere herein. Process starts at a step 505 where a user who has passed the pre-qualification check and who is logged in to the service enters the qualification process. After the step 505, processing proceeds to a test step 510 where it is determined whether the MDUI validity of mobile device has been verified in a previous qualification check. In some embodiments, the step 510 may be performed locally on the mobile device. Note that a user whose MDUI validity has been previously verified would have been already enrolled in a promotional premium offer and therefore should not have passed the pre-qualification check at the step 410, described above. Accordingly, a mobile device with functioning software might have a positive answer at the test step 510 because the current attempt is an attempt of unauthorized access to the system. Accordingly, in the case of positive answer at the test step 510, processing proceeds to a step 515 where a warning is displayed to the user. After the step 515, processing proceeds to a step 517 where the user account is marked as non-qualifying. Following the step 517, processing is complete.

If it is determined at the test step 510 that the validity of the MDUI has not been previously verified, then processing proceeds to a step 520 where a first data exchange between the software on the user's device and the service occurs. The software retrieves and encrypts the MDUI and submits the encrypted MDUI to the service. In some embodiments, processing at the step 520 includes creating a service bound copy of the MDUI to prevent malicious users from intercepting, broadcasting and using broadcasted original device MDUIs for improper purposes, such as abusing the promotional premium offer and other user functionality at the software and/or the service level. After the step 520, processing proceeds to a step 530 where the service (server-based software) decrypts the submitted encrypted MDUI and compares the MDUI against a full list of previously recorded MDUIs for promotion enabled mobile devices and user accounts.

After the step 530, processing proceeds to a test step 540 where it is determined whether the new MDUI is on the previously compiled list of activated promotional premium subscriptions. One reason why the new MDUI might already be on the list is reformatting of the mobile device or uninstallation and re-installation of the software by the user for technical or other reason. Otherwise, the MDUI should be new for the service and will not appear on the previously compiled list. If it is determined at the test step 540 that the MDUI is not on the master list, processing proceeds to a step 545 where MDUI is added to the master list. Otherwise, if it is determined at the test step 540 that the MDUI is on the master list, then processing proceeds to a step 550 (which also follows the step 545) where a local flag on the user's device is set to record a successful attempt of MDUI verification. Setting the flag may avoid future unnecessary MDUI submissions and checks. After the step 550, processing proceeds to a step 560 where the user account is marked as qualifying for the promotional premium offer. Following the step 550, processing is complete.

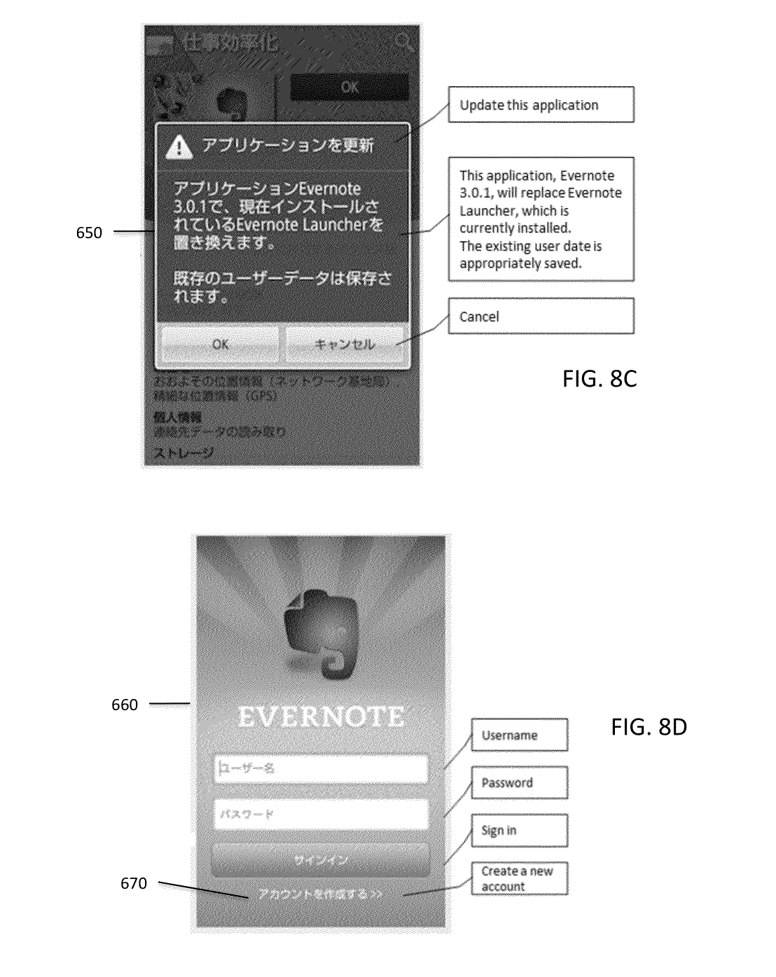

FIGS. 8A-8D are schematic illustrations 600 showing user interface components and messages corresponding to several embodiments of the system described herein. FIG. 8A shows an embodiment of a landing page for a promotional premium offer displayed on a mobile device. The landing page includes general information 610, a download link accessible via button 615, and a link to additional information via a button 620.

FIG. 8B shows a software download, update and feedback page, hosted in a mobile marketplace. In one embodiment, the mobile operator hosts such pages for all promotional software offers running on the network of the operator. The page includes an instant update (software upgrade) button 630 and an auto-upgrade option (checkbox) 640, as well as explanatory text and a user feedback portion.

FIG. 8C shows a software download dialog 650 for an embodiment where the software, upon installation from a download link, replaces the software launcher and assumes the functions of the software. In one embodiment, the software may be further auto-upgraded by the service for different reasons, including consolidation of the master lists of mobile device models for which promotional premium offer is available. FIG. 8D shows a service login page 660 with an option 670 for a first-time user to create a new service account.

Various embodiments discussed herein may be combined with each other in appropriate combinations in connection with the system described herein. Additionally, in some instances, the order of steps in the flowcharts, flow diagrams and/or described flow processing may be modified, where appropriate. Subsequently, elements and areas of screen described in screen layouts may vary from the illustrations presented herein. Further, various aspects of the system described herein may be implemented using software, hardware, a combination of software and hardware and/or other computer-implemented modules or devices having the described features and performing the described functions. The mobile device may be a cell phone, although other devices are also possible.

Software implementations of the system described herein may include executable code that is stored in a computer readable medium and executed by one or more processors. The computer readable medium may be non-transitory and include a computer hard drive, ROM, RAM, flash memory, portable computer storage media such as a CD-ROM, a DVD-ROM, a flash drive, an SD card and/or other drive with, for example, a universal serial bus (USB) interface, and/or any other appropriate tangible or non-transitory computer readable medium or computer memory on which executable code may be stored and executed by a processor. The system described herein may be used in connection with any appropriate operating system.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A method of managing software and service provided to a device by a service provider, comprising:
performing a pre-qualification check for availability of a premium promotional version of the service for the device, wherein the pre-qualification check is performed off-line and includes a determination if the device is in a table of devices for which the premium promotional version is available;
performing an online qualification check for availability of a premium promotional version of the service for the device in response to passing the pre-qualification check; and
offering the premium promotional version of the service in response to passing the qualification check.

2. A method, according to claim 1, wherein the pre-qualification check includes determining if there is already a premium account associated with the device.

3. A method, according to claim 1, wherein the pre-qualification check includes determining if there is already a free service account associated with the device.

4. A method, according to claim 1, wherein the qualification check includes determining if an identifier of the device indicates that a qualification check was previously performed for the device.

5. A method, according to claim 1, wherein the qualification check includes providing, via the Internet, an identifier from the device to the service provider and wherein the identifier is encrypted prior to being transmitted to provide an encrypted identifier from the device to the service provider.

6. A method, according to claim 5, wherein a server compares the encrypted identifier with a database of previously-provided encrypted identifiers.

7. A method, according to claim 6, wherein a device being upgraded to the premium promotional version of the software uses the encrypted identifier as a gift code to obtain the premium promotional service.

8. A method, according to claim 1, wherein the device is a cell phone and wherein the table of devices is provided by a mobile operator.

9. A method, according to claim 1, wherein the device is initially loaded with a software launcher that determines if the device has a correct version of software prior to the pre-qualification check.

10. A method, according to claim 9, wherein the software launcher causes the correct version of the software to be loaded into the device prior to the pre-qualification check.

11. Computer software, provided in a non-transitory computer-readable medium, that manages software and service provided to a device by a service provider, the software comprising:
executable code that performs a pre-qualification check for availability of a premium promotional version of the service for the device, wherein the pre-qualification check is performed off-line and includes a determination if the device is in a table of devices for which the premium promotional version is available;
executable code that performs an online qualification check for availability of a premium promotional version of the service for the device in response to passing the pre-qualification check; and
executable code that offers the premium promotional version of the service in response to passing the qualification check.

12. Computer software, according to claim 11, wherein the pre-qualification check includes determining if there is already a premium account associated with the device.

13. Computer software, according to claim 11, wherein the pre-qualification check includes determining if there is already a free service account associated with the device.

14. Computer software, according to claim 11, wherein the qualification check includes determining if an identifier of the device indicates that a qualification check was previously performed for the device.

15. Computer software, according to claim 11, wherein the qualification check includes providing, via the Internet, an identifier from the device to the service provider and wherein the identifier is encrypted prior to being transmitted to provide an encrypted identifier from the device to the service provider.

16. Computer software, according to claim 15, wherein a server compares the encrypted identifier with a database of previously-provided encrypted identifiers.

17. Computer software, according to claim 16, wherein a device being upgraded to the premium promotional version of the software uses the encrypted identifier as a gift code to obtain the premium promotional service.

18. Computer software, according to claim 17, wherein the device is a cell phone and wherein the table of devices is provided by a mobile operator.

19. Computer software, according to claim 11, wherein the device is initially loaded with a software launcher that determines if the device has a correct version of software prior to the pre-qualification check.

20. Computer software, according to claim 19, wherein the software launcher causes the correct version of the software to be loaded into the device prior to the pre-qualification check.
